(19) United States
(12) Patent Application Publication
(10) Pub. No.: US 2018/0039962 A1
(43) Pub. Date: Feb. 8, 2018

(54) INFORMATION PROCESSING METHOD, TERMINAL AND SERVER, AND COMPUTER STORAGE MEDIUM

(71) Applicant: TENCENT TECHNOLOGY (SHENZHEN) COMPANY LIMITED, Shenzhen (CN)

(72) Inventors: Jie REN, Shenzhen (CN); Jie TU, Shenzhen (CN); Yanping TANG, Shenzhen (CN); Canchong XU, Shenzhen (CN); Bin LUO, Shenzhen (CN); Yuye WANG, Shenzhen (CN); Jianwu LIANG, Shenzhen (CN)

(73) Assignee: TENCENT TECHNOLOGY (SHENZHEN) COMPANY LIMITED, Shenzhen (CN)

(21) Appl. No.: 15/785,512

(22) Filed: Oct. 17, 2017

Related U.S. Application Data
(63) Continuation of application No. PCT/CN2016/083371, filed on May 25, 2016.

(30) Foreign Application Priority Data
Sep. 9, 2015 (CN) 201510570472.5

(51) Int. Cl. G06Q 20/14; H04L 29/06

(52) U.S. Cl. CPC G06Q 20/14; H04L 67/42; G06Q 40/025

(57) ABSTRACT

Aspects of the disclosure provide a terminal device that includes an interface circuitry and a processing circuitry. The interface circuitry is configured to interface the terminal device to a network, and transmit and receive signals to/from a server and other terminal devices via the network. The server provides service functionality to users who are registered with the server in a service network. The terminal device is utilized by a first user who is registered in the service network, and is associated with one or more friend users in the service network. The processing circuitry is configured to cause the interface circuitry to send a first application request to a second terminal device that is utilized by a friend user, receive a first response that is generated based on a first input on the second terminal device in response to the first application request, and receive a processing result of the first application request that is determined by the server based on the first response.

### RELATED APPLICATION

This application is a continuation of International Application No. PCT/CN2016/083371, filed on May 25, 2016, which claims priority to Chinese Patent Application No. 201510570472.5, filed on Sep. 9, 2015. The entire disclosures of the prior applications are hereby incorporated by reference herein in their entirety.

### FIELD OF THE TECHNOLOGY

The present disclosure relates to Internet technologies, and in particular, to an information processing method, a terminal and a server, and a computer storage medium.

### BACKGROUND OF THE DISCLOSURE

As intelligent terminals are widely used, many life services can be implemented online by using the intelligent terminals. For example, a payment service can be implemented by installing Internet transaction-based applications (such as WeBank and MyBank) in an intelligent terminal. For another example, Internet financial products such as Yu'e Bao, Xinyongbao, and Weilidai provide life services to users based on applications that are installed in the intelligent terminal. One of the provided life services is an Internet transaction function. Internet transactions implemented by using the applications are mostly based on a timely and convenient feature of the Internet, so as to convert conventional offline finance to finance in an Internet plus form.

However, currently, when Internet transactions are implemented by using the applications, a data analysis capability of the Internet that is much stronger than that offline is rarely used. For example, when a user's personal credit is customized offline, usually, a repayment capability of the user is determined simply according to history transaction details, an account balance, and an income status of the user, to customize a credit line. Similarly, in this manner, information exchange is performed offline (for example, by using a contract agreement between two parties). It can be seen that a processing result of this type of information exchange is not real-time and accurate. Still using the Internet transactions as an example, offline customization of a user's personal credit still causes that a processing result is relatively statically determined. In this case, accurate and real-time credit rating and credit line customization cannot be implemented. For this problem, there is no effective resolution in the existing technology.

### SUMMARY

Aspects of the disclosure provide a terminal device that includes an interface circuitry and a processing circuitry. The interface circuitry is configured to interface the terminal device to a network, and transmit and receive signals to/from a server and other terminal devices via the network. The server provides service functionality to users who are registered with the server in a service network. The terminal device is utilized by a first user who is registered in the service network, and is associated with one or more friend users in the service network. The processing circuitry is configured to cause the interface circuitry to send a first application request to a second terminal device that is utilized by a friend user, receive a first response that is generated based on a first input on the second terminal device in response to the first application request, and receive a processing result of the first application request that is determined by the server based on the first response.

According to an aspect of the disclosure, the processing circuitry is configured to cause the interface circuitry to receive a second response that is generated based on a second input on a third terminal device that is utilized by another user associated with the friend user in the service network. The second response is generated in response to a second application request that is generated based on the first application request, and the processing circuitry is configured to cause the interface circuitry to receive the processing result of the first application request that is determined by the server based on the first response and the second response.

In an embodiment, the processing circuitry is configured to generate a packet including account information of the first user in the service network, and cause the interface circuitry to transmit the packet to the server to determine a first upper limit for a service resource allocation based on the account information and a second upper limit based on the account information and the first and second responses.

In an example, the processing circuitry is configured to cause the interface circuitry to send the first application request that includes a value indicative of an amount of a service resource to request, and a qualification disclosure.

Aspects of the disclosure provide a server that includes a network interface circuitry and a processing circuitry. The network interface circuitry is configured to interface the server to a network to provide a service to users who are registered with the server in a service network, and transmit and receive signals to/from terminal devices via the network. The processing circuitry is configured to cause the network interface circuitry to receive a first application request that is sent by a first terminal device utilized by a first user to a second terminal device utilized by a friend user associated with the first user in the service network, and receive a first response that is generated based on a first input on the second terminal device in response to the first application request, and process the first application request based on the first response.

Aspects of the disclosure provide a method. The method includes receiving, by a network interface circuitry of a server that provides a service to users who are registered with the server in a service network, a first application request that is sent by a first terminal device utilized by a first user to a second terminal device utilized by a friend user associated with the first user in the service network, receiving, by the network interface circuitry, a first response that is generated based on a first input on the second terminal device in response to the first application request, and processing, by processing circuitry of the server, the first application request based on the first response.

Aspects of the disclosure provide a method. The method includes transmitting, by an interface circuitry that interfaces a first terminal device to a server and other terminal devices via a network, a first application request to a second terminal device. The server provides service functionality to users who are registered with the server in a service network. The first terminal device is utilized by a first user who is registered in the service network, and the second terminal device is utilized by a friend user associated with the first user. The method further includes receiving, by the interface circuitry, a first response that is generated based on a first input on the second terminal device in response to the first application request and receiving, by the interface circuitry, a processing result of the first application request that is determined by the server based on the first response.

According to an aspect of the disclosure, a final processing result of an entire information exchange based on Internet applications in the service network is real-time and accurate. Specifically, in an example, a corresponding credit line is customized by means of a joint guarantee manner in a social relationship chain, and an offline relatively static joint guarantee is moved to the Internet, thereby implementing more accurate and real-time credit rating and credit line customization.

### BRIEF DESCRIPTION OF THE DRAWINGS

FIG. 1 is a schematic flowchart of a first embodiment of an information processing method according to the present disclosure;

FIG. 2 is a schematic flowchart of a second embodiment of an information processing method according to the present disclosure;

FIG. 3 is a schematic flowchart of a first embodiment of another information processing method according to the present disclosure;

FIG. 4 is a schematic flowchart of a second embodiment of another information processing method according to the present disclosure;

FIG. 5 is a schematic structural diagram of an embodiment of a server according to the present disclosure;

FIG. 6 is a schematic structural diagram of another embodiment of a server according to the present disclosure;

FIG. 7 is a schematic structural diagram of an embodiment of a terminal according to the present disclosure;

FIG. 8 is a schematic diagram of an application scenario of an information processing method according to the present disclosure;

FIG. 9 is a schematic diagram of another application scenario of an information processing method according to the present disclosure;

FIG. 10 is a schematic diagram of a hardware entity of a server embodiment according to the present disclosure; and

FIG. 11 is a schematic diagram of a hardware entity of a terminal embodiment according to the present disclosure.

### DESCRIPTION OF EMBODIMENTS

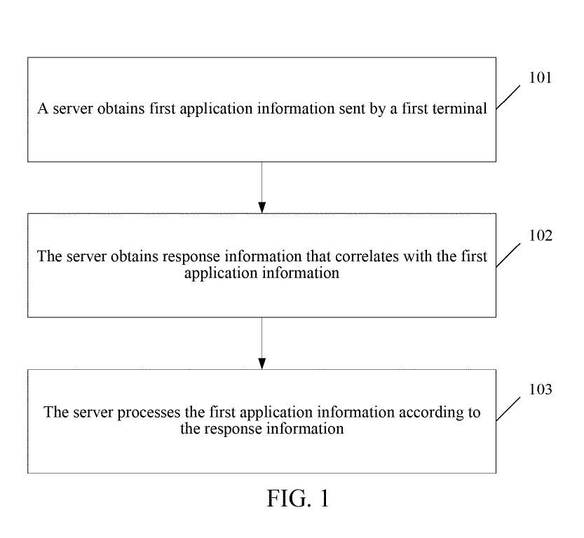

A first embodiment of an information processing method provided in the present disclosure is applied to the Internet. As shown in FIG. 1, the method includes the following steps.

Step 101: A server obtains first application information sent by a first terminal, the first application information being sent by the first terminal to a second terminal in direct association with the first terminal.

Herein, the first application information includes a guaranteed amount request and a risk disclosure.

Step 102: The server obtains response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or the third terminal based on the first application information and being sent to a terminal that is in direct association with the second terminal and/or the third terminal.

Herein, the response information includes guaranteed amount confirmation.

Step 103: The server processes the first application information according to the response information.

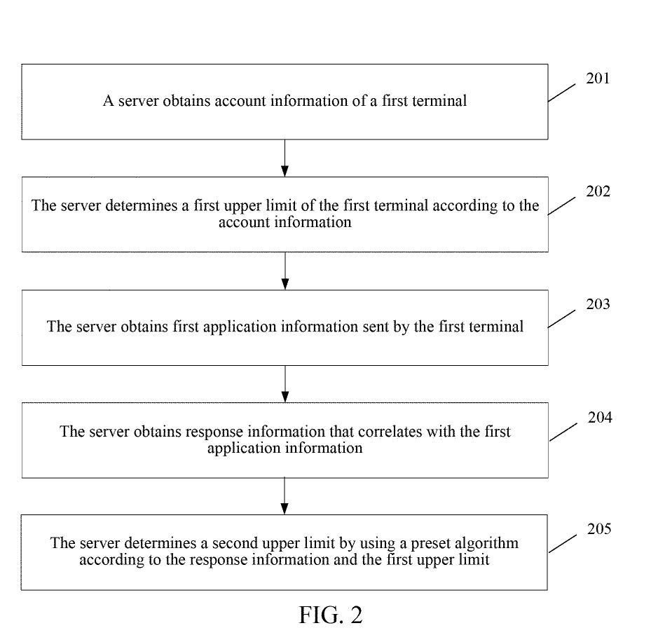

A second embodiment of the information processing method provided in the present disclosure is applied to the Internet. As shown in FIG. 2, the method includes the following steps.

Step 201: A server obtains account information, such as a credit reporting history and/or financial information, and the like of an account of the first terminal.

Herein, the credit reporting history is information obtained in a legal manner, and may be obtained from a system, or may be obtained from a user uploading history. Specifically, user information obtained from the system is obtained in a regular manner, for example, by querying a credit reporting history in the Central Bank of China. The information is obtained in a legal manner. User information obtained from a user uploading history is information authorized by a user, and therefore, is obtained in a regular manner For example, a credit reporting history is obtained by querying an income certificate, a consumption certificate, a tax receipt, and the like that are uploaded by a user. The information is obtained in a legal manner.

Step 202: Determine a first upper limit of a service resource, such as a first credit line of the first terminal according to the account information, such as the credit reporting history and/or the financial information.

Step 203: The server obtains first application information sent by the first terminal, the first application information being sent by the first terminal to a second terminal in direct association with the first terminal.

Herein, the first application information includes a value indicative of an amount to request (e.g., a guaranteed amount request) and a qualification disclosure (e.g., a risk disclosure).

Step 204: The server obtains response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or the third terminal based on the first application information and being sent to a terminal that is in direct association with the second terminal and/or the third terminal.

Herein, in an embodiment, the response info, information is indicative of a confidence level of a service resource allocation. For example, the response information includes a guaranteed amount confirmation.

Step 205: The server determines a second upper limit of the service resource, such as a second credit line by using a preset algorithm according to the response information and the first credit line.

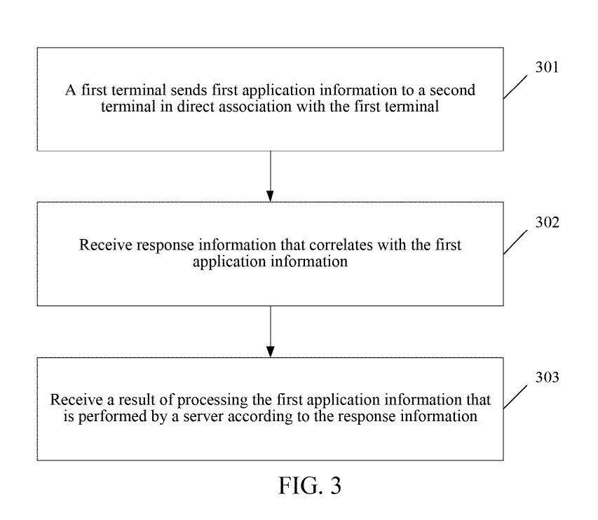

A first embodiment of another information processing method provided in the present disclosure is applied to the Internet. As shown in FIG. 3, the method includes the following steps.

Step 301: A first terminal sends first application information to a second terminal in direct association with the first terminal.

Herein, the first application information includes a guaranteed amount request and a risk disclosure.

Step 302: Receive response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or the third terminal based on the first application information and being sent to a terminal that is in direct association with the second terminal and/or the third terminal.

Herein, the response information includes a guaranteed amount confirmation.

Step 303: Receive a result of processing, by a server according to the response information, the first application information.

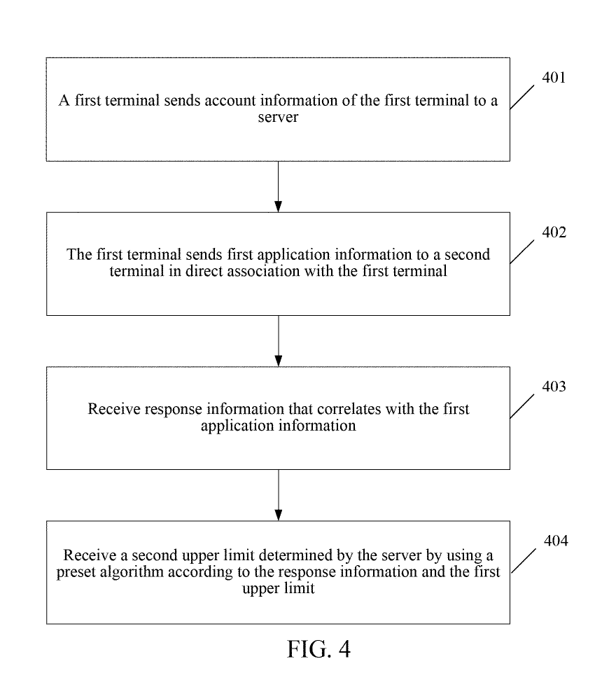

A second embodiment of the information processing method provided in the present disclosure is applied to the Internet. As shown in FIG. 4, the method includes the following steps.

Step 401: The first terminal sends account information, such as financial information of an account of the first terminal to the server, so that the server determines a first credit line of the first terminal according to a credit reporting history and/or financial information of the account of the first terminal, and determines a second credit line by using a preset algorithm according to the response information and the first credit line.

Step 402: The first terminal sends first application information to a second terminal in direct association with the first terminal.

Herein, the first application information includes a guaranteed amount request and a risk disclosure.

Step 403: Receive response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or the third terminal based on the first application information and being sent to a terminal that is in direct association with the second terminal and/or the third terminal.

Herein, the response information includes a guaranteed amount confirmation.

Step 404: Receive a second credit line determined by the server by using a preset algorithm according to the response information and the first credit line.

An embodiment of a server provided in the present disclosure is applied to the Internet. As shown in FIG. 5, the server includes:

a first obtaining unit 501, configured to obtain first application information sent by a first terminal, the first application information being sent by the first terminal to a second terminal in direct association with the first terminal, where

the first application information includes a guaranteed amount request and a risk disclosure;

a second obtaining unit 502, configured to obtain response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or the third terminal based on the first application information and being sent to a terminal that is in direct association with the second terminal and/or the third terminal, where

the response information includes a guaranteed amount confirmation; and

a processing unit 503, configured to process the first application information according to the response information.

In an example, the first obtaining unit 501 and the second obtaining unit 502 are implemented using a network interface circuitry of the server, and the processing unit 503 is implemented using a processing circuitry (processors) of the server.

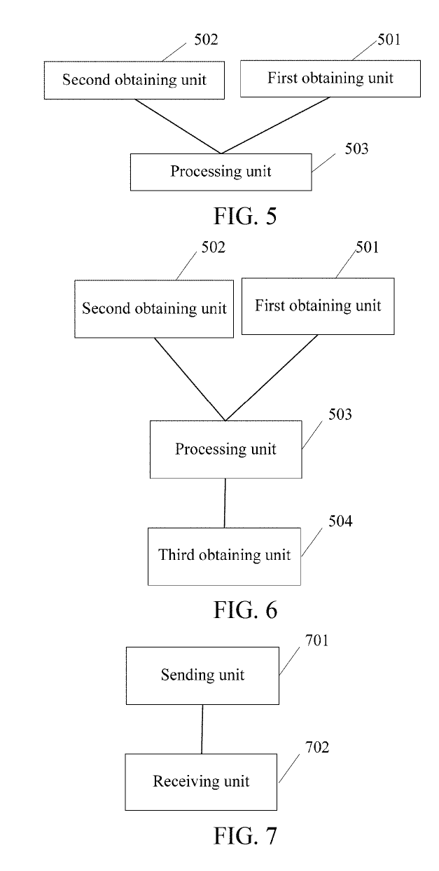

In an embodiment, as shown in FIG. 6, the server further includes a third obtaining unit 504, configured to obtain a credit reporting history and/or financial information of an account of the first terminal. The third obtaining unit 504 can be implemented using the network interface circuitry of the server.

The processing unit 503 is configured to determine a first credit line of the first terminal according to the credit reporting history and/or the financial information, and determine a second credit line by using a preset algorithm according to the response information and the first credit line.

During actual application, each unit in the server may be implemented by using a central processing unit (CPU), a digital signal processor (DSP), or a field programmable gate array (FPGA).

An embodiment of a terminal provided in the present disclosure is applied to the Internet. As shown in FIG. 7, the terminal includes:

a sending unit 701, configured to send first application information to a second terminal in direct association with the sending unit, where

the first application information includes a guaranteed amount request and a risk disclosure; and

a receiving unit 702, configured to receive response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or the third terminal based on the first application information and being sent to a terminal that is in direct association with the second terminal and/or third terminal; and configured to receive a result of processing the first application information that is performed by a server according to the response information, where

the response information includes guaranteed amount confirmation.

In an embodiment, the sending unit 701 is further configured to send financial information of an account of the sending unit to the server, so that the server determines a first credit line of the first terminal according to a credit reporting history and/or financial information of the account of the first terminal, and determines a second credit line by using a preset algorithm according to the response information and the first credit line.

The receiving unit 702 is configured to receive the second credit line determined by the server by using a preset algorithm according to the response information and the first credit line.

During actual application, each unit in the terminal may be implemented by using a central processing unit (CPU), a digital signal processor (DSP), or a field programmable gate array (FPGA). In an example, the sending unit 701 and the receiving unit 702 are implemented using an interface circuitry, and the terminal includes a processing circuitry to cause the interface circuitry to receive and transmit signals.

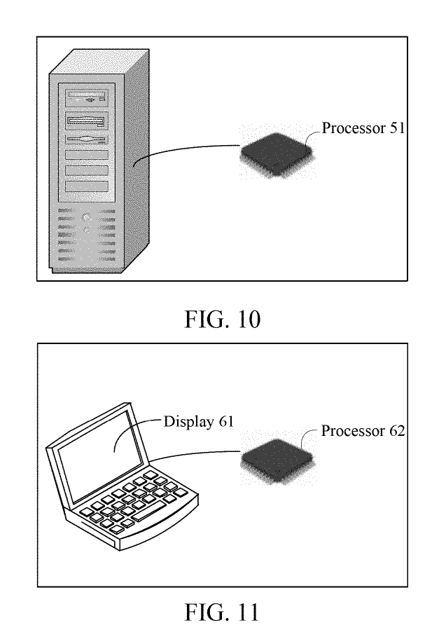

An embodiment of the present disclosure provides a server. As shown in FIG. 10, the server includes a processor 51, configured to perform the following operations by means of executable instructions:

obtaining first application information sent by a first terminal, the first application information being sent by the first terminal to a second terminal in direct association with the first terminal;

obtaining response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or the third terminal based on the first application information and being sent to a terminal that is in direct association with the second terminal and/or the third terminal; and processing the first application information according to the response information.

An embodiment of the present disclosure provides a terminal. As shown in FIG. 11, the terminal includes a display 61 and a processor 62. The display 61 is configured to display information in the user interface. The processor 62 is configured to perform the following operations by means of executable instructions:

sending first application information to a second terminal in direct association with the terminal;

receiving response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or the third terminal based on the first application information and being sent to a terminal that is in direct association with the second terminal and/or third terminal; and configured to receive a result of processing the first application information that is performed by a server according to the response information.

Correspondingly, a computer storage medium provided in an embodiment of the present disclosure stores computer programs, and the computer programs are used to perform the foregoing information processing method.

The technical solutions of the present disclosure are further described in detail with reference to accompanying drawings and specific embodiments below.

In the existing technology, life services are provided to users based on applications that are installed in intelligent terminals. One of the provided life services is implementation of an Internet transaction function. When Internet transactions are implemented by using the applications, information exchange is performed offline (for example, by using a contract agreement between two parties). A processing result of this type of information exchange is not real-time and accurate. Still using the Internet transactions as an example, a relatively static determination manner causes many disadvantages. In this case, when a contract related to a large amount is customized in a conventional financial system, comprehensive credit manners such as “re-guarantee” and “joint guarantee” emerge. Herein, the joint guarantee is also referred to as jo-guarantee, distributed guarantee, or shared guarantee, which means that two or more guarantee agencies provide guarantee to a same creditor's right. The joint guarantee is actually joint guaranty in the Guaranty Law. Even if a result is comprehensive, accurate and real-time credit rating and credit line customization cannot be implemented either.

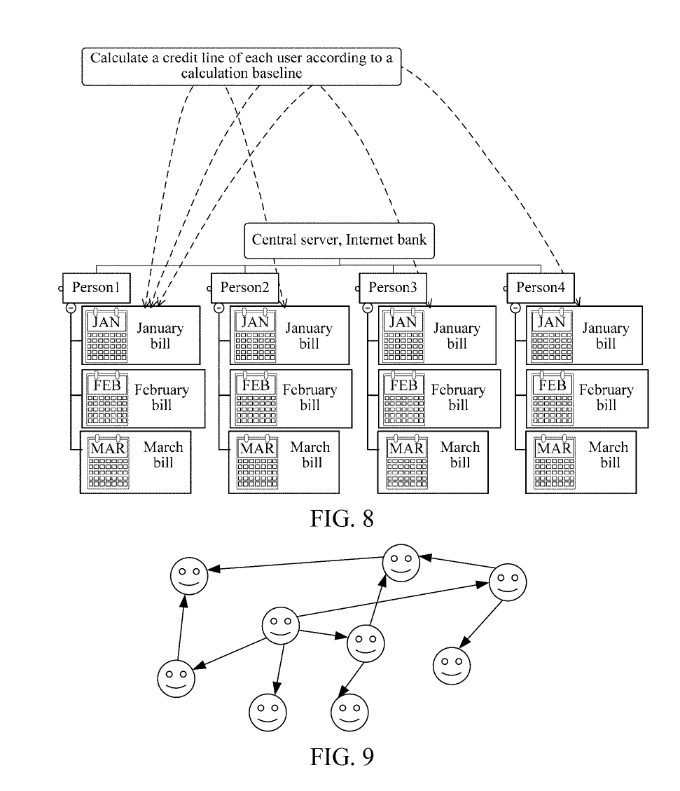

In this embodiment of the present disclosure, first, a static Internet friend relationship link needs to be used to establish a diagram of a network among Internet financial users; then, information entropy of each node is calculated by means of the network diagram, as shown in FIG. 8; and then the information entropy is converted into an initial credit line for each user at a ratio.

Herein, the Internet friend relationship link is existing information of a social network company. This type of information may be used in credit investigation analysis of an Internet financial company. In addition, it should be noted that, the information entropy of each node of the network diagram is an amount of information included in the node. The node herein is a person who suggests a credit amount in a manner of, for example, querying a credit investigation system of the Central Bank of China.

During actual application, conversion of information entropy (credit amounts) of other nodes (persons) at a ratio is similar to that a person x informs his friends such as a, b, and c of upper amount limits that can be separately guaranteed by the friends, to increase his (x's) credit amount. When applying for credit line adjustment, a user may send a real-time guarantee application message to a friend, with no need to record transaction cases of a few months or even a few years. However, in an example, the recording is required in credit line increases for conventional credit cards. After receiving the guarantee application information, the user's Internet financial friend may determine an amount which he is willing to guarantee for his friend within an upper credit line limit, and may also apply to his friend for a credit line guarantee.

If a guarantee line of a friend of an applicant is not used up, the friend can still provide a guarantee. If the guarantee line of the friend is used up, he can remind the applicant to send a guarantee application to his friend, so that he can deliver an amount which he cannot guarantee to his friend for guarantee. This is equivalent to that his friend can guarantee a credit line. If the second-level friend for guarantee confirms a risk disclosure, guarantee effectiveness is the same as that of the first-level friend for guarantee. A credit line is not related to a quantity of guarantee applications, but is related only to a total amount of the guarantee applications. A system algorithm is used to calculate an upper amount limit which each node (person) in the relationship link can guarantee for another person after the system is stable after many guarantee applications are sent.

Herein, the application message may carry an expected amount (within an amount limit which a friend can guarantee) which a friend can guarantee and a risk disclosure. Herein, it should be noted that, the foregoing upper credit line limit is an amount which a friend can guarantee after the system is stable and that is calculated by the system, so that risks caused by multiple guarantees are reduced. It is not difficult to understand that, in this embodiment of the present disclosure, a friend is required to have a credit repayment capability. A condition of a joint guarantee is responsibility sharing in an example.

In this way, corresponding amounts can be guaranteed by friends. Therefore a relationship link of financial guarantees is implemented by means of social networks, thereby establishing a stronger joint guarantee network. A credit line (popularity) of the applicant that can be increased to in the guarantee network may be calculated by using a PageRank algorithm according to the real-time applications and confirmation among friends. This is similar to calculation of web page popularity.

A finally achieved effect is that a user can maximize his credit line within a controllable risk range by means of multi-level guarantees, and an Internet financial company can also maximize loan benefits thereof in this manner.

The information processing method in this embodiment of the present disclosure mainly includes the following steps.

1. Establish an Initial Credit Line System

Referring to FIG. 8, an initial credit line is determine by using a conventional credit line calculation method, for example, querying a credit reporting history of the Central Bank of China, or querying an income certificate, a consumption certificate, a tax receipt, and the like that are uploaded by a current applicant. A financial institution may autonomously query a credit reporting history in the Central Bank of China. An applicant may be reminded to upload a certificate about assets of the applicant.

The foregoing description is a credit system of China. In America, with the development of an American credit system, cognition of “credit” has matured in the whole society. Using “personal credit” as an example, connotation thereof includes character, capability, capital, condition, collateral, and stability. In addition, a boundary of credit is clearly described. That is, a consensus is reached on data basis used to quantize credit. The entire credit system includes institution credit and personal credit. The institution credit includes capital market credit and enterprise credit. Capital market credit institutions include Standard and Poor's, Moody's, Fitch, and the like. Enterprise credit institutions include Dun & Bradstreet Corporation and the like. In the personal credit system, credit institutions include Experian, Equifax, TransUnion, and the like. In addition, In the American credit system, over 400 regional or professional credit institutions are attached to the foregoing seven institutions, or provide data to the institutions. Using personal credit as an example, in an industry chain, the first link is data collection of which sources are relatively rich. This can help institutions to monitor personal credit statuses more comprehensively. Then, the data is standardized. For example, in a second link, Metro 1 and Metro 2 are uniform standard data report format and standard data collection format that are constituted by American Credit Resolution (ACR) and that are used for personal credit services. This type of standard is a very important milestone of development of the credit industry. The third link is that three major credit institutions process a large amount of data, so as to form credit products, including scores, reports, and the like. Finally, the data is applied to various applications, such as personal house tenancies or dealing with loan services. For a Southeast Asian credit system, big data is a quite direct manner in inclusive finance. Only 60% or 70% of clients have bank credit histories. In addition, in other markets in the Asia-Pacific region, such as the Indonesia market or some other Southeast Asian markets, conventional client credit reports having bank credit histories generally occupy 50% or 60%. In the entire emerging markets, many countries do not have bank credit services. However, there are relatively blooming financial demands or credit demands in the countries. The demands mainly come from families with low income and small-scale enterprises. As the big data emerges, it may be considered that credit statuses of the families with low income and small-scale enterprises and statuses of related transactions may be cognized from another point of view. Actually, the behaviors may recognize potential risks. This helps clients who couldn't have been financial institution clients become financial institution clients. In addition, for parts that the clients do not dare to apply for credit line customization, financial institutions may help the clients to apply for credit line customization. Therefore, the big data can essentially help clients to obtain help from financial institutions, so as to avoid obtaining loans with more risks from some worse markets.

2. Real-Time Joint Guarantee Application and Credit Line Adjustment

Referring to FIG. 9, a credit line (e.g., as a function of popularity) that can be applied for by each node (user) after adjustment is calculated by using PageRank algorithm according to an application case. If a friend is willing to provide a guarantee, the credit line may be adjusted in real time according to a guarantee status in the relationship link.

Herein, the PageRank algorithm is a Google rating algorithm. The PageRank algorithm is applied to web page rating which is also referred to as web page level, and is a standard algorithm that determines web page popularity by means of a technology that performs calculation according to mutual hyperlinks between web pages and according to a status of that relationship links are called among websites. The PageRank algorithm is an element of web page rating, and can be used to embody relativity and importance of web pages. In operations of searching engine optimization, the algorithm is usually used to evaluate one effective factor of web page optimization. The PageRank algorithm determines a level of a web page according to a complex hyperlink relationship of networks. Google explains a link form a page A to a page B as that the page A votes for the page B. Google determines a new level according to a vote source (or even a source of the source, that is, a page that is linked to the page A) and a level of a voted object. Simply, a higher-level page may raise a level of another lower-level page.

In this embodiment of the present disclosure, innovation in terminals is based on an entire credit service solution, so as to implement a real-time joint guarantee operation by means of a terminal, and send an expected amount which a friend can guarantee in real time, so that the friend can make real-time confirmation after reading a risk disclosure.

3. User Credit Line Adjustment

A credit line application is completed by means of the foregoing real-time operation, thereby maximizing benefits of an applicant and an Internet financial company.

A rule of corresponding credit line is constituted by means of the joint guarantee manner in a social relationship chain, and an offline relatively static joint guarantee is moved to the Internet, thereby finally implementing more accurate and real-time credit rating and credit line customization. A finally achieved effect is that a user can maximize his credit line within a controllable risk range by means of multi-level guarantees, and an Internet financial company can also maximize loan benefits thereof in this manner.

To sum up, in the embodiments of the present disclosure, a joint guarantee is implemented, in an Internet form, in a dynamic determining manner that combines online and offline services in information exchange processing, so that a final processing result by using the information exchange in the embodiments of the present disclosure is real-time and accurate, thereby maximizing benefits of two parties in this convenient, rapid, and real-time manner.

When the integrated module in the embodiments of the present disclosure is implemented in a form of a software functional module and sold or used as an independent product, the integrated module may be stored in a computer readable storage medium. Based on the foregoing content, a person skilled in the art should understand that the embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media that include computer-usable program code. The storage media includes but is not limited to a USB flash drive, removable hard disk, a read-only memory (ROM), a magnetic disk, a CD-ROM, an optical memory, and the like.

This application is described with reference to the flowcharts and/or block diagrams of the method, the device (system), and the computer program product according to the embodiments of the application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of this application have been described, persons skilled in the art can make changes and modifications to these embodiments once they learn the basic inventive concept. Therefore, the following claims are intended to be construed as to cover the preferred embodiments and all changes and modifications falling within the scope of this application.

### INDUSTRIAL APPLICABILITY

The technical solutions of the embodiments of the present disclosure include: obtaining, by a server, first application information sent by a first terminal, the first application information being sent by the first terminal to a second terminal in direct association with the first terminal; obtaining, by the server, response information that correlates with the first application information, the response information including first response information sent by the second terminal according to the first application information, and second response information sent by a third terminal according to second application information, the third terminal being in direct or indirect association with the second terminal, and the second application information being generated by the second terminal and/or third terminal based on the first application information and being sent to a terminal that is in direct association with the second terminal and/or the third terminal; and processing, by the server, the first application information according to the response information, so that a final processing result of the entire information exchange based on Internet applications is real-time and accurate. Specifically, a corresponding credit line is customized by means of a joint guarantee manner in a social relationship chain, and an offline relatively static joint guarantee is moved to the Internet, thereby implementing more accurate and real-time credit rating and credit line customization.

What is claimed is:

1. A terminal device, comprising:
an interface circuitry configured to interface the terminal device to a network, and transmit and receive signals to/from a server and other terminal devices via the network, the server being configured to provide service functionality to users who are registered with the server in a service network, and the terminal device being utilized by a first user who is registered in the service network, and is associated with one or more friend users in the service network; and
a processing circuitry configured to cause the interface circuitry to send a first application request to a second terminal device that is utilized by a friend user, receive a first response that is generated based on a first input on the second terminal device in response to the first application request, and receive a processing result of the first application request that is determined by the server based on the first response.

2. The terminal device of claim 1, wherein the processing circuitry is configured to cause the interface circuitry to receive a second response that is generated based on a second input on a third terminal device that is utilized by another user associated with the friend user in the service network, the second response is generated in response to a second application request that is generated based on the first application request, and the processing circuitry is configured to cause the interface circuitry to receive the processing result of the first application request that is determined by the server based on the first response and the second response.

3. The terminal device of claim 2, wherein the processing circuitry is configured to generate a packet that includes account information of the first user in the service network, and cause the interface circuitry to transmit the packet to the server to determine a first upper limit for a service resource allocation based on the account information and a second upper limit based on the account information and the first and second responses.

4. The terminal device of claim 1, wherein the processing circuitry is configured to cause the interface circuitry to send the first application request that includes a value indicative of an amount of a service resource to request, and a qualification disclosure.

5. The terminal device of claim 2, wherein the processing circuitry is configured to cause the interface circuitry to receive the first response and the second response that are indicative of a confidence level of a service resource allocation.

6. A server, comprising:
a network interface circuitry configured to interface the server to a network to provide a service to users who are registered with the server in a service network, and transmit and receive signals to/from terminal devices via the network; and
a processing circuitry configured to cause the network interface circuitry to receive a first application request that is sent by a first terminal device utilized by a first user to a second terminal device utilized by a friend user associated with the first user in the service network, and receive a first response that is generated based on a first input on the second terminal device in response to the first application request, and process the first application request based on the first response.

7. The server of claim 6, wherein the processing circuitry is configured to cause the network interface circuitry to receive a second response that is generated based on a second input on a third terminal device utilized by another user associated with the friend user in the service network, and process the first application request based on the first response and the second response, the second response is generated in response to a second application request that is generated based on the first application request.

8. The server of claim 7, wherein the processing circuitry is configured to cause the network interface circuitry to receive the first application request that includes a value indicative of an amount of a service resource to request, and a qualification disclosure, and receive the first response and the second response that are indicative of a confidence level of a service resource allocation.

9. The server of claim 7, wherein the processing circuitry is configured to cause the network interface circuitry to receive account information of the first user in the service network, and to determine a first upper limit of a service resource allocation based on the account information, and a second upper limit of the service resource allocation based on the first response and the second response.

10. The server of claim 8, wherein the processing circuitry is configured to cause the network interface circuitry to receive account information of the first user in the service network, and to determine a first upper limit of the service resource allocation based on the account information, and a second upper limit of the service resource allocation based on the first response and the second response.

11. A method, comprising:
receiving, by a network interface circuitry of a server that provides a service to users who are registered with the server in a service network, a first application request that is sent by a first terminal device utilized by a first user to a second terminal device utilized by a friend user associated with the first user in the service network;
receiving, by the network interface circuitry, a first response that is generated based on a first input on the second terminal device in response to the first application request; and
processing, by a processing circuitry of the server, the first application request based on the first response.

12. The method of claim 11, comprising:
receiving, by the network interface circuitry, a second response that is generated based on a second input on a third terminal device that is utilized by another user associated with the friend user in the service network, the second response being generated in response to a second application request that is generated based on the first application request; and
processing, by the processing circuitry of the server, the first application request based on the first response and the second response.

13. The method of claim 12, further comprising:
receiving, by the network interface circuitry, the first application request that includes a value indicative of amount of service resource to request, and a qualification disclosure; and
receiving, by the network interface circuitry, the first response and the second response that are indicative of a confidence level of a service resource allocation.

14. The method of claim 12, further comprising:
receiving, by the network interface circuitry, account information of the first user in the service network; and
determining, by the processing circuitry, a first upper limit of a service resource allocation based on the account information, and a second upper limit of the service resource allocation based on the first response and the second response.

15. The method of claim 13, further comprising:
receiving, by the network interface circuitry, account information of the first user in the service network; and
determining, by the processing circuitry, a first upper limit of a service resource allocation based on the account information, and a second upper limit of the service resource allocation based on the first response and the second response.
